(19) United States
(12) Patent Application Publication
(10) Pub. No.: US 2010/0122608 A1
(43) Pub. Date: May 20, 2010

(54) Open-Ended Ratchet Wrench

(76) Inventor: Chen-Tsung Chen, Jiali Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/272,091

(22) Filed: Nov. 17, 2008

(51) Int. Cl. B25B 13/46; B25B 13/08

(52) U.S. Cl. 81/60; 81/119

(57) ABSTRACT

An open-ended ratchet wrench includes a handle provided with an open driving head, an open ratchet wheel mounted in the driving head of the handle and having an outer wall provided with a plurality of oneway ratchet teeth, and a pawl member movably mounted in the driving head of the handle and having a first side provided with a plurality of oneway locking teeth detachably meshing with the ratchet teeth of the ratchet wheel. Thus, the ratchet wheel has a side provided with an opening to make the ratchet wheel flexible so that the ratchet wheel is mounted on and detached from the workpiece easily and quickly, thereby facilitating a user operating the ratchet wrench to rotate the workpiece.

### BACKGROUND OF THE INVENTION

1. Field of the Invention

The present invention relates to a ratchet wrench and, more particularly, to an open-ended ratchet wrench.

2. Description of the Related Art

A conventional open end wrench comprises a handle having two opposite ends each provided with a substantially C-shaped operation head. Thus, the operation head of the handle is mounted on a workpiece, such as a hexagonal nut, bolt and the like, so as to operate and rotate the workpiece by rotation of the handle. However, the operation head of the handle cannot rotate the workpiece successively, so that a user has to mount the operation head of the handle on the workpiece and to remove the operation head of the handle from the workpiece in an alternating manner, thereby greatly causing inconvenience to the user when operating the operation head of the handle to rotate the workpiece.

### BRIEF SUMMARY OF THE INVENTION

In accordance with the present invention, there is provided an open-ended ratchet wrench, comprising a handle provided with an open driving head, an open ratchet wheel mounted in the driving head of the handle and having an outer wall provided with a plurality of oneway ratchet teeth, and a pawl member movably mounted in the driving head of the handle and having a first side provided with a plurality of oneway locking teeth detachably meshing with the ratchet teeth of the ratchet wheel.

The open-ended ratchet wrench further comprises a cover mounted on the driving head of the handle and abutting the pawl member and the elastic member to retain the pawl member and the elastic member in the driving head of the handle.

The open-ended ratchet wrench further comprises an elastic member mounted in the driving head of the handle and biased between the driving head of the handle and a second side of the pawl member to push the locking teeth of the pawl member toward the ratchet teeth of the ratchet wheel.

The open-ended ratchet wrench further comprises an open retaining ring located between the driving head of the handle and the ratchet wheel to retain the ratchet wheel in the driving head of the handle.

The primary objective of the present invention is to provide an open-ended ratchet wrench that is operated to drive a workpiece in an energy-saving manner.

Another objective of the present invention is to provide an open-ended ratchet wrench, wherein the ratchet wheel has a side provided with an opening to make the ratchet wheel flexible so that the ratchet wheel is mounted on and detached from the workpiece easily and quickly, thereby facilitating a user operating the ratchet wrench to rotate the workpiece.

A further objective of the present invention is to provide an open-ended ratchet wrench, wherein the ratchet wheel is fully encompassed by the stop flange of the driving head so that the ratchet wheel will not be exposed outwardly from the driving head of the handle to prevent the ratchet wheel from being worn out or broken due to an accidental hit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an open-ended ratchet wrench in accordance with the preferred embodiment of the present invention.

FIG. 2 is an exploded perspective view of the open-ended ratchet wrench as shown in FIG. 1.

FIG. 3 is a top cross-sectional view of the open-ended ratchet wrench as shown in FIG. 1.

FIG. 4 is a cross-sectional view of the open-ended ratchet wrench taken along line 4-4 as shown in FIG. 3.

FIG. 5 is a schematic operational view of the open-ended ratchet wrench as shown in FIG. 3.

FIG. 6 is a perspective view of an open-ended ratchet wrench in accordance with another preferred embodiment of the present invention.

### DETAILED DESCRIPTION OF THE INVENTION

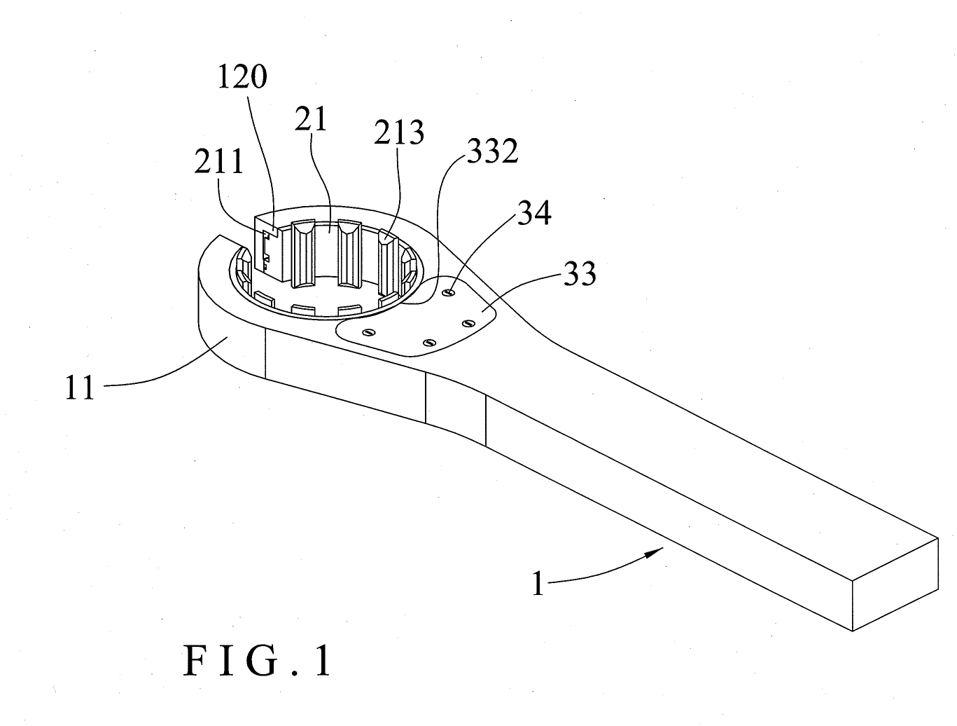

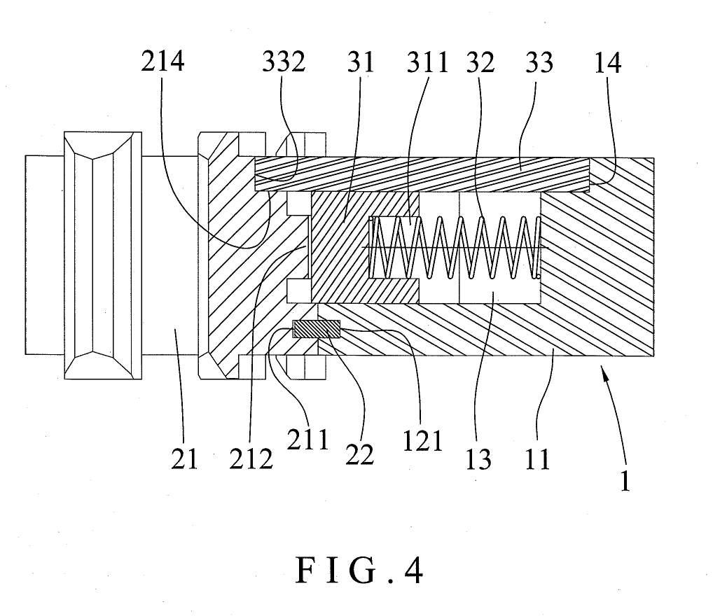

Referring to the drawings and initially to FIGS. 1-4, an open-ended ratchet wrench in accordance with the preferred embodiment of the present invention comprises a handle 1 provided with an open driving head 11, an open ratchet wheel 21 mounted in the driving head 11 of the handle 1 and having an outer wall provided with a plurality of oneway ratchet teeth 212, a pawl member 31 movably mounted in the driving head 11 of the handle 1 and having a first side provided with a plurality of oneway locking teeth 310 detachably meshing with the ratchet teeth 212 of the ratchet wheel 21, an elastic member 32 mounted in the driving head 11 of the handle 1 and biased between the driving head 11 of the handle 1 and a second side of the pawl member 31 to push the locking teeth 310 of the pawl member 31 toward the ratchet teeth 212 of the ratchet wheel 21, a cover 33 mounted on the driving head 11 of the handle 1 and abutting the pawl member 31 and the elastic member 32 to retain the pawl member 31 and the elastic member 32 in the driving head 11 of the handle 1, and an open retaining ring 22 located between the driving head 11 of the handle 1 and the ratchet wheel 21 to retain the ratchet wheel 21 in the driving head 11 of the handle 1.

The handle 1 has one end provided with the driving head 11. The driving head 11 of the handle 1 has an inner wall provided with a receiving chamber 12 to receive the ratchet wheel 21. The receiving chamber 12 of the driving head 11 has a side provided with a receiving space 13 to receive the pawl member 31 and the elastic member 32. The receiving chamber 12 of the driving head 11 has a top provided with a radially and inwardly extending stop flange 120 abutting the ratchet wheel 21 and a bottom provided with a retaining slot 121 to retain the retaining ring 22. The driving head 11 of the handle 1 has a substantially C-shaped profile and has a side provided with a first opening 110 connected to the receiving chamber 12 and located opposite to the receiving space 13. The driving head 11 of the handle 1 has a top provided with a receiving depression 14 to receive the cover 33. The receiving depression 14 of the driving head 11 is connected to the receiving space 13 and the receiving chamber 12. The receiving depression 14 of the driving head 11 has a bottom wall provided with a plurality of screw bores 141.

The ratchet wheel 21 has an inner wall provided with a plurality of radially and inwardly extending pressing bosses 213. Each of the pressing bosses 213 of the ratchet wheel 21 has a substantially arc-shaped profile. The ratchet wheel 21 has a substantially C-shaped profile and has a side provided with a second opening 210 that is movable to align with the first opening 110 of the driving head 11. The ratchet wheel 21 is fully encompassed by the stop flange 120 of the driving head 11. The ratchet wheel 21 has a top provided with a stepped resting edge 214 abutting the stop flange 120 of the driving head 11 and the cover 33 and a bottom provided with a retaining groove 211 to retain the retaining ring 22. The ratchet teeth 212 of the ratchet wheel 21 are located between the resting edge 214 and the retaining groove 211.

The retaining ring 22 has a substantially C-shaped profile and has a side provided with a third opening 220 aligning with the first opening 110 of the driving head 11 and the second opening 210 of the ratchet wheel 21. The retaining ring 22 has an inner wall retained in the retaining groove 211 of the ratchet wheel 21 and an outer wall retained in the retaining slot 121 of the driving head 11.

The cover 33 has a size greater than that of the receiving space 13 of the driving head 11 and has a side 332 extending into the receiving chamber 12 of the driving head 11 and abutting the resting edge 214 of the ratchet wheel 21. The cover 33 is provided with a plurality of fixing holes 331, and the open-ended ratchet wrench further comprises a plurality of locking screws 34 extending through the fixing holes 331 and screwed into the screw bores 141 of the driving head 11 to lock the cover 33 onto the driving head 11 of the handle 1.

The second side of the pawl member 31 has a first face provided with a smooth resting portion 312 that is movable to abut a periphery of the receiving depression 14 of the driving head 11 and a second face provided with a mounting recess 311 to receive the elastic member 32.

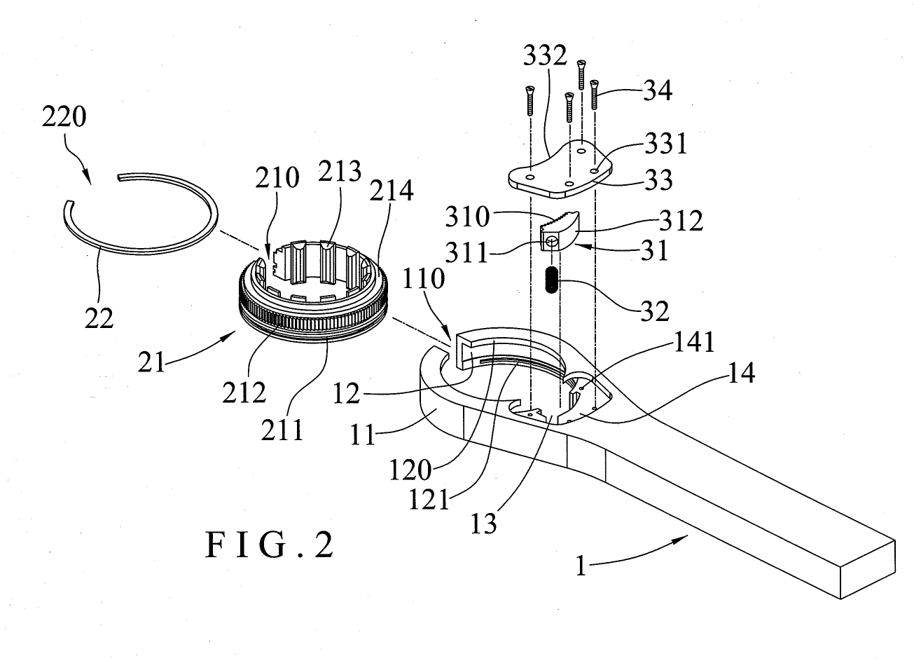

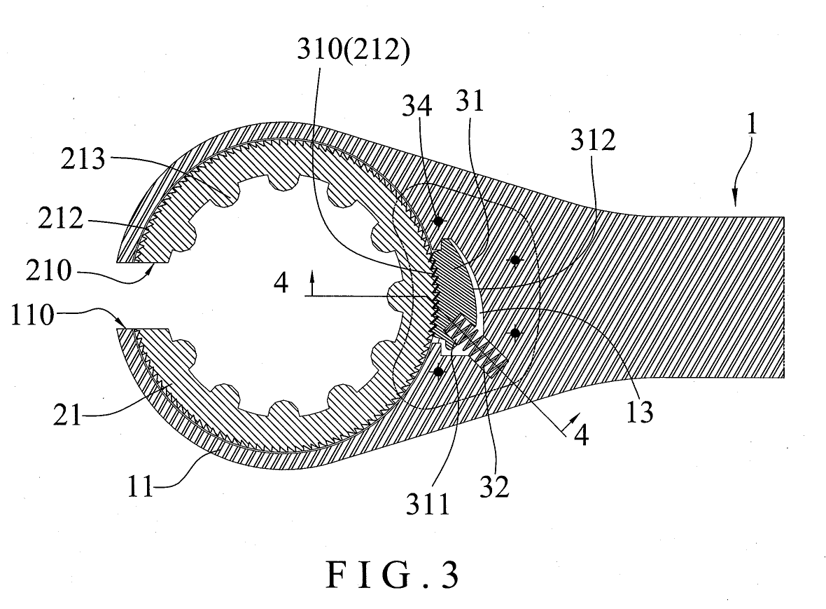

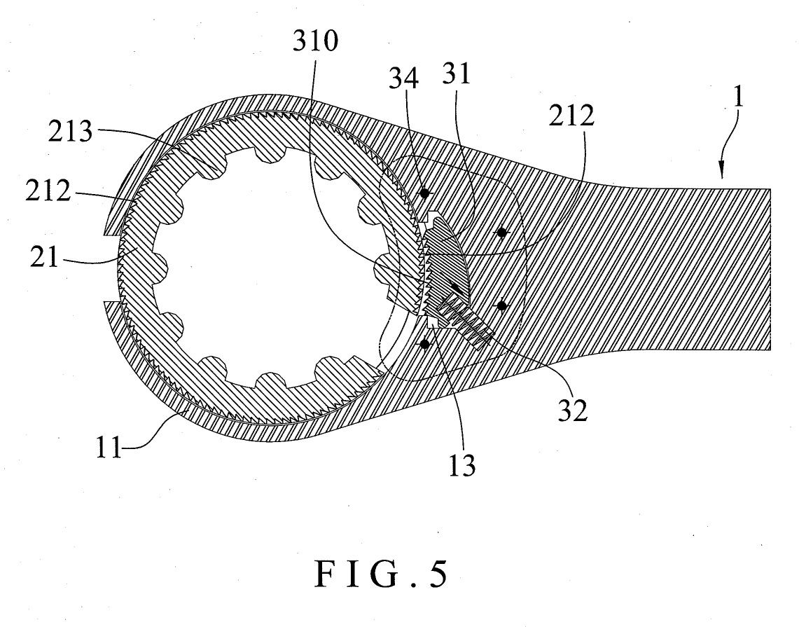

In operation, referring to FIGS. 3-5 with reference to FIGS. 1 and 2, the ratchet wheel 21 is mounted on a workpiece, such as a bolt, nut and the like, with the pressing bosses 213 of the ratchet wheel 21 pressing the periphery of the workpiece. In such a manner, when the driving head 11 of the handle 1 is rotated in the clockwise direction as shown in FIG. 3, the oneway locking teeth 310 of the pawl member 31 mesh with the ratchet teeth 212 of the ratchet wheel 21, so that the ratchet wheel 21 is driven by the driving head 11 of the handle 1 to rotate the workpiece in the clockwise direction. On the contrary, when the driving head 11 of the handle 1 is rotated in the counterclockwise direction as shown in FIG. 5, the oneway locking teeth 310 of the pawl member 31 disengage the ratchet teeth 212 of the ratchet wheel 21, so that the ratchet wheel 21 is not driven by the driving head 11 of the handle 1, and the driving head 11 of the handle 1 idles in the clockwise direction. Thus, the workpiece is driven by the driving head 11 of the handle 1 to rotate in a oneway direction only.

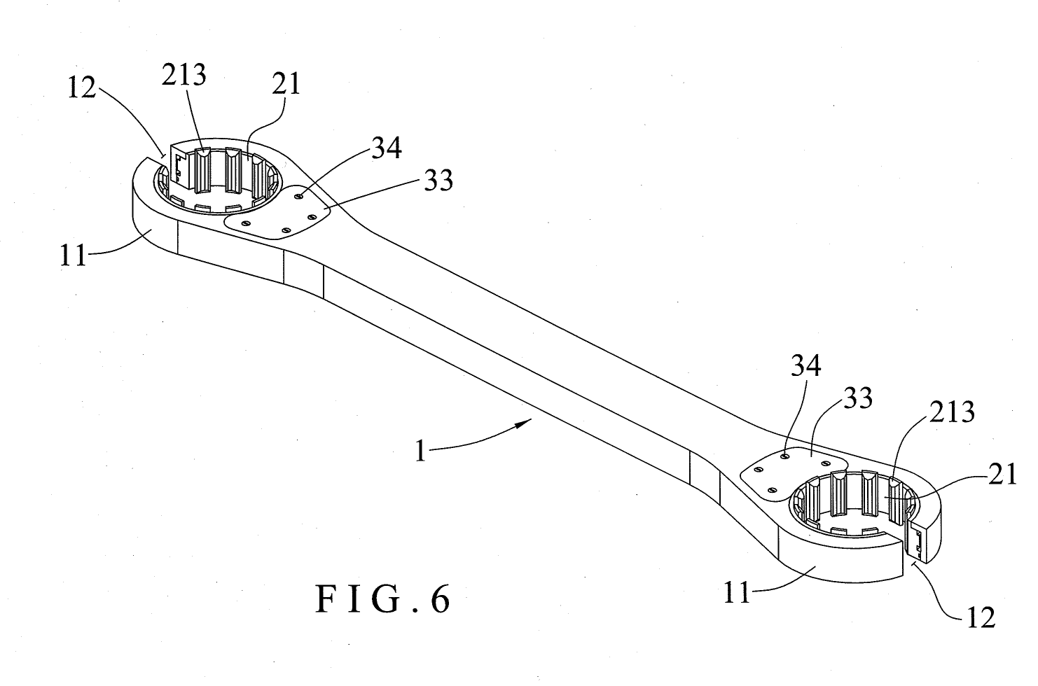

As shown in FIG. 6, the handle 1 has two opposite ends each provided with the driving head 11.

Accordingly, the ratchet wheel 21 has a side provided with an opening to make the ratchet wheel 21 flexible so that the ratchet wheel 21 is mounted on and detached from the workpiece easily and quickly, thereby facilitating a user operating the ratchet wrench to rotate the workpiece. In addition, the ratchet wheel 21 is fully encompassed by the stop flange 120 of the driving head 11 so that the ratchet wheel 21 will not be exposed outwardly from the driving head 11 of the handle 1 to prevent the ratchet wheel 21 from being worn out or broken due to an accidental hit.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An open-ended ratchet wrench, comprising:
a handle provided with an open driving head;
an open ratchet wheel mounted in the driving head of the handle and having an outer wall provided with a plurality of oneway ratchet teeth;
a pawl member movably mounted in the driving head of the handle and having a first side provided with a plurality of oneway locking teeth detachably meshing with the ratchet teeth of the ratchet wheel.

2. The open-ended ratchet wrench of claim 1, further comprising:
a cover mounted on the driving head of the handle and abutting the pawl member and the elastic member to retain the pawl member and the elastic member in the driving head of the handle;
an elastic member mounted in the driving head of the handle and biased between the driving head of the handle and a second side of the pawl member to push the locking teeth of the pawl member toward the ratchet teeth of the ratchet wheel.

3. The open-ended ratchet wrench of claim 2, wherein
the driving head of the handle has an inner wall provided with a receiving chamber to receive the ratchet wheel;
the receiving chamber of the driving head has a side provided with a receiving space to receive the pawl member and the elastic member;
the driving head of the handle has a top provided with a receiving depression to receive the cover.

4. The open-ended ratchet wrench of claim 3, wherein
the driving head of the handle has a side provided with a first opening connected to the receiving chamber and located opposite to the receiving space;
the ratchet wheel has a side provided with a second opening that is movable to align with the first opening of the driving head.

5. The open-ended ratchet wrench of claim 4, further comprising:
an open retaining ring located between the driving head of the handle and the ratchet wheel to retain the ratchet wheel in the driving head of the handle.

6. The open-ended ratchet wrench of claim 5, wherein the retaining ring has a side provided with a third opening aligning with the first opening of the driving head and the second opening of the ratchet wheel.

7. The open-ended ratchet wrench of claim 5, wherein
the receiving chamber of the driving head has a top provided with a radially and inwardly extending stop flange abutting the ratchet wheel and a bottom provided with a retaining slot to retain the retaining ring;
the ratchet wheel has a top provided with a stepped resting edge abutting the stop flange of the driving head and the cover and a bottom provided with a retaining groove to retain the retaining ring.

8. The open-ended ratchet wrench of claim 7, wherein the ratchet teeth of the ratchet wheel are located between the resting edge and the retaining groove.

9. The open-ended ratchet wrench of claim 3, wherein the receiving depression of the driving head is connected to the receiving space and the receiving chamber.

10. The open-ended ratchet wrench of claim 1, wherein the ratchet wheel has an inner wall provided with a plurality of radially and inwardly extending pressing bosses.

11. The open-ended ratchet wrench of claim 10, wherein each of the pressing bosses of the ratchet wheel has a substantially arc-shaped profile.

12. The open-ended ratchet wrench of claim 7, wherein the ratchet wheel is fully encompassed by the stop flange of the driving head.

13. The open-ended ratchet wrench of claim 7, wherein the retaining ring has an inner wall retained in the retaining groove of the ratchet wheel and an outer wall retained in the retaining slot of the driving head.

14. The open-ended ratchet wrench of claim 3, wherein the cover has a size greater than that of the receiving space of the driving head.

15. The open-ended ratchet wrench of claim 7, wherein the cover has a side extending into the receiving chamber of the driving head and abutting the resting edge of the ratchet wheel.

16. The open-ended ratchet wrench of claim 3, wherein
the receiving depression of the driving head has a bottom wall provided with a plurality of screw bores;
the cover is provided with a plurality of fixing holes;
the open-ended ratchet wrench further comprises a plurality of locking screws extending through the fixing holes and screwed into the screw bores of the driving head to lock the cover onto the driving head of the handle.

17. The open-ended ratchet wrench of claim 3, wherein the second side of the pawl member has a first face provided with a smooth resting portion that is movable to abut a periphery of the receiving depression of the driving head and a second face provided with a mounting recess to receive the elastic member.

18. The open-ended ratchet wrench of claim 6, wherein
the driving head of the handle has a substantially C-shaped profile;
the ratchet wheel has a substantially C-shaped profile;
the retaining ring has a substantially C-shaped profile;

19. The open-ended ratchet wrench of claim 1, wherein the handle has one end provided with the driving head.

20. The open-ended ratchet wrench of claim 1, wherein the handle has two opposite ends each provided with the driving head.
